(19) United States
(12) Patent Application Publication
(10) Pub. No.: US 2008/0007683 A1
(43) Pub. Date: Jan. 10, 2008

(54) WIRING STRUCTURE AND DISPLAY DEVICE

(75) Inventor: Masanobu MAKIDA, Hyogo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI ELECTRIC CORPORATION, Chiyoda-ku (JP)

(21) Appl. No.: 11/760,976

(22) Filed: Jun. 11, 2007

(30) Foreign Application Priority Data
Jun. 20, 2006 (JP) 2006-169987

(51) Int. Cl. G02F 1/1343

(52) U.S. Cl. 349/139

(57) ABSTRACT

A wiring structure according to an embodiment of the present invention includes: a plurality of lead-out lines of different lengths formed on a substrate; a plurality of line cut portions corresponding to the plurality of lead-out lines and cutting the lead-out lines; and a connection portion connecting the lead-out lines cut by the line cut portion, wherein a connection conductive film connecting the lead-out line cut by the line cut portion is formed in the connection portion, and at least one of a width of the connection conductive film and a length of the line cut portion is changed between the plurality of lead-out lines in accordance with a resistance difference between the plurality of lead-out lines.

### BACKGROUND OF THE INVENTION

1. Field of the Invention

The present invention relates to a wiring structure and a display device. In particular, the present invention relates to a wiring structure including plural lead-out lines, and a display device using the wiring structure.

2. Description of Related Art

General existing liquid crystal display devices include plural gate lines (scanning signal lines) and source lines (image signal lines) arranged in matrix. In liquid crystal display panels, plural liquid crystal cells correspond to intersections between the gate lines and the source lines. The plural gate signal lines are driven by a gate driving IC. The plural source lines are driven by a source driving IC.

The gate lines and source lines are formed on a liquid crystal surface side of a liquid crystal display panel. Each line is led out from a display area to a driving IC. The line is led out along a space around the display area (hereinafter also referred to as “frame area”). The length of the line led out to the display area varies depending on a mounting position of the driving IC. This causes an uneven display area due to a resistance difference between lines. To reduce the resistance difference between lines, the line length and width are controlled by use of the space as the frame area, but it is difficult to reduce a disparity in difference and suppress display unevenness.

The length of the lead-out line varies depending on a position of the driving IC or line layout. For example, the length of the lead-out line varies depending on whether the line is led out clockwise or counterclockwise around the display area. In a liquid crystal display panel having a large external panel size and fewer display pixels, there is a large frame space where each line is led out from the driving IC to the display area. Thus, for example, if the lead-out length of a source line varies depending on whether the line is led out clockwise or counterclock wise around the display area like the layout of the source driving IC, the line length and width are adjusted. As a result, a resistance difference between lines can be adjusted.

However, a sufficient frame space becomes hard to ensure along with a recent tendency toward high-definition display and a small external size of a display panel. Thus, a lead-out line should be formed almost to the limit width to design. In this case, enough space cannot be ensured, and it is difficult to adjust a resistance by adjusting the line width. Therefore, a resistance needs to be adjusted by adjusting the line length alone. In this case, as described above, the line length is limited by the position of the driving IC, making it difficult to suppress display unevenness due to a resistance difference between lines.

For example, according to the related art disclosed in Japanese Unexamined Patent Application Publication No. 2000-187451, a frame space is utilized to adjust resistance difference between lines. However, it is difficult to ensure a sufficient frame space and suppress display unevenness along with a recent tendency toward high-definition display and a small external size of a display panel.

As described above, in the conventional liquid crystal display device, the length differs between the lead-out lines, leading to a disparity in resistance between lines. This causes a problem of uneven display.

### SUMMARY OF THE INVENTION

The present invention has been accomplished with a view to solving the above problems. The present invention aims at providing a wiring structure capable of adjusting a resistance between lead-out lines in a simple manner and a display device using the same.

A wiring structure according to an aspect of the present invention includes: a plurality of lead-out lines of different lengths formed on a substrate; a plurality of line cut portions corresponding to the plurality of lead-out lines and cutting the lead-out lines; and a connection portion connecting the lead-out lines cut by the line cut portion, wherein a connection conductive film connecting the lead-out line cut by the line cut portion is formed in the connection portion, and at least one of a width of the connection conductive film and a length of the line cut portion is changed between the plurality of lead-out lines in accordance with a resistance difference between the plurality of lead-out lines.

A wiring structure according to another aspect of the present invention includes: a plurality of lead-out lines including a first conductive layer formed on a substrate; a second conductive layer formed on the first conductive layer; a lower insulating film formed between the first conductive layer and the second conductive layer; two connection portions corresponding to the plurality of lead-out line and provided in the lead-out line such that a segment of the lead-out line has a laminate structure of the first conductive layer and the second conductive layer; and a connection conductive film connecting between the first conductive layer and the second conductive layer in the connection portion, wherein in the two connection portions, at least one of a width and length of the second conductive layer is changed between the plurality of lead-out lines in accordance with a resistance difference between the plurality of lead-out lines.

According to the present invention, it is possible to provide a wiring structure capable of adjusting a resistance difference between lead-out lines in a simple manner and a display device using the same.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1A is a plan view of a structural example of a liquid crystal panel according to the present invention, and FIG. 1B is a sectional view of a structural example of a liquid crystal panel of FIG. 1A;

FIG. 2 is a plan view of a structural example of a connection area of a liquid crystal panel according to a first embodiment of the present invention;

FIGS. 3A to 3C are schematic diagrams of a structural example of the connection area of the liquid crystal panel of the first embodiment;

FIGS. 4A and 4B are schematic diagrams of a structural example of a connection area of a liquid crystal panel according to a second embodiment of the present invention;

FIGS. 5A to 5C are schematic diagrams of a structural example of a connection area of a liquid crystal panel according to a third embodiment of the present invention;

FIG. 6 is a schematic diagram of a structural example of a connection area of a liquid crystal panel according to a fourth embodiment of the present invention;

FIGS. 7A and 7B are schematic diagrams of a structural example of a connection area of a liquid crystal panel according to a fifth embodiment of the present invention;

FIGS. 8A to 8C are schematic diagrams of a structural example of the connection area of the liquid crystal panel of the fifth embodiment;

FIG. 9 is a plan view of a structural example of a liquid crystal panel according to a sixth embodiment of the present invention;

FIG. 10 is a plan view of a structural example of a liquid crystal panel according to a seventh embodiment of the present invention; and

FIG. 11 shows the configuration of a test circuit of a liquid crystal panel according to an eighth embodiment of the present invention.

### DESCRIPTION OF THE PREFERRED EMBODIMENTS

The following first to eighth embodiments describe a liquid crystal display device as a preferred embodiment of a display device of the present invention. However, a display device that embodies the present invention is not limited to the liquid crystal display device but may be a display device including scanning signal lines, image signal lines, and a driving IC for driving these lines. Incidentally, there is no particular limitation on the driving IC. For example, the driving IC may be a COG (chip on glass) type driver configured such that a driving IC is put on a display panel or an outboard TAB driver. Further, the eighth embodiment describes the wiring structure of the present invention which is applied to a test circuit for a display panel, but the eighth embodiment is not limited thereto, and any circuit including the wiring structure of the present invention can be used. In particular, the wiring structure of the present invention is suitable for suppressing display unevenness of the display device.

### First Embodiment

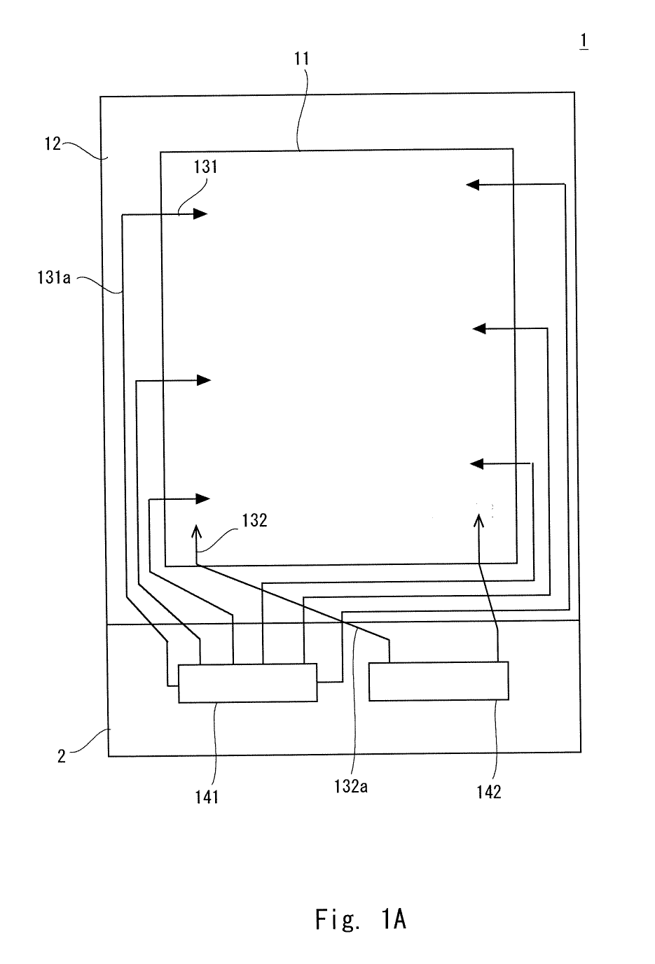

Referring to FIG. 1A and FIG. 1B, the schematic diagram of a liquid crystal display panel according to the present invention is described. FIG. 1A is a plan view of a structural example of the liquid crystal display panel according to the present invention, and FIG. 1B is a sectional view of a structural example of the liquid crystal display panel of FIG. 1A. FIG. 1A and FIG. 1B illustrate a main portion thereof.

As shown in FIG. 1A, a liquid crystal display panel 1 typically includes a display area 11 composed of plural pixels arranged in matrix and a frame area 12 formed around the display area 11. That is, a non-display area surrounding the display area 11 is the frame area 12. As shown in FIG. 1B, the liquid crystal display panel 1 includes an array substrate 2 where lines and an array circuit are formed and an opposing substrate 4 that is opposite to the array substrate 2. A liquid crystal 6 is filled in between the two substrates. A counter electrode 5 made up of a transparent conductive film is formed on the opposing substrate 4 through color filter layers 3. In an active matrix type liquid crystal panel, each pixel has a switching element for controlling input/output of an image signal. A typical switching element is a TFT (Thin Film Transistor).

A color liquid crystal display device has RGB color filter layers 3 on the opposing substrate 4. Each pixel in the display area of the liquid crystal panel 1 displays one of RGB colors. Needless to say, each pixel displays a white or black color in a monotone display. A predetermined pattern is formed on a transparent glass substrate to thereby form the array substrate 2 and the opposing substrate 4. A transparent counter electrode 5 is formed on the array substrate 2 side of the opposing substrate 4. A backlight unit 7 is formed on the rear side of the liquid crystal panel 1.

Plural source lines 132 and plural gate lines 131 are formed in matrix in the display area 11 on the array substrate 2. That is, the array substrate 2 is a wiring board. In the example of FIG. 1A, each of the source lines 132 extends along the vertical direction. The source lines 132 formed along the vertical direction area arranged in the horizontal direction. In FIG. 1A, the source lines 132 of the same width are formed at regular intervals. On the other hand, the gate lines 131 are arranged in the horizontal direction in the display area 11. The gate lines 131 formed in the horizontal direction are arranged in the vertical direction. In the display area 11, the gate lines 131 are arranged at regular pitches.

In the frame area 12, the gate driving IC 141 and the source driving IC 142 are arranged. The gate driving IC 141 and the source driving IC 142 are arranged in the frame area 12 below the display area 11. A portion of the frame area 12 below the display area 11 is referred to as “lower of the frame area 12”. A portion of the frame area 12 on both sides of the display area is referred to as “side of the frame area 12”. The side of the frame area 12 includes a right-handed side portion and a left-handed side portion. Further, a portion of the frame area 12 above the display area 11 is referred to as “upper of the frame area 12”. The display area 11 is surrounded by the upper of the frame area 12, the right-handed of the frame area 12, the left-handed of the frame area 12, and the lower of the frame area 12. In addition, each driving IC is provided on the lower side of the display area 11.

The source lines 132 and the gate lines 131 are substantially orthogonal to each other through a gate insulating film, and TFTs are formed around intersections thereof. For example, the gate insulating film is formed to cover the gate line 131 and a gate electrode extending from the gate line 131. The gate insulating film may be formed of silicon oxide or silicon nitride. A semiconductor film is formed on the gate insulating film. As the semiconductor film, an a-Si or p-Si film can be used. A source electrode extending from the source line 132 is formed on the semiconductor film. A source voltage can be applied to the source region of the semiconductor film. Further, a drain electrode is formed on a drain region of the semiconductor film. The source electrode and the drain electrode can be formed in the same process as the source line. The gate line and the source line maybe formed of a low-resistance metal material, for example, Al or Cr. As described above, the gate line 131 and the source line 132 are formed in different wiring layers.

The interlayer insulating film is formed on the drain electrode. A pixel electrode is formed on the interlayer insulating film. The drain electrode is connected with the pixel electrode through a contact hole formed in the interlayer insulating film. If the liquid crystal display panel 1 is a light-transmissive type, the pixel electrode is formed of a transparent conductive film such as ITO. Thus, if a gate signal is applied to the gate line, a gate voltage is applied to a predetermined gate electrode. A TFT is turned ON to thereby apply an image-display signal voltage to the pixel electrode from the source electrode through the drain electrode.

A control signal is externally supplied to the gate driving IC 141. Display data is externally supplied to the source driving IC 142. The gate driving IC 141 and the source driving IC 142 display an image based on the control signal and the display data. That is, each pixel selected based on the gate voltage applied from the gate driving IC 141 applies an electric field to liquid crystal based on an image-display signal voltage applied from the source driving IC 142. Thus, grain orientation of the liquid crystal is changed to control an amount of transmitted light. The source driving IC 142 for supplying the image-display signal voltage to the source line 132 and the gate driving IC 141 for supplying the gate voltage to the gate line 131 are connected to the frame area 12 of the array substrate 2, which is formed around the display area.

A gate lead-out line 131a is formed between the gate line 131 and the gate driving IC 141. Plural gate lead-out lines 131a and plural gate lines 131 are formed in a one-to-one correspondence. That is, as many gate lead-out lines 131a as the gate lines 131 are formed on the array substrate 2. The plural gate lead-out lines 131a are formed in the frame area 12. The gate driving IC 141 and the gate line 131 are connected through the gate lead-out line 131a. That is, a gate signal is supplied from the gate driving IC 141 through the gate lead-out line 131a.

A source lead-out line 132a is formed between the source line 132 and the source driving IC 142. Plural source lead-out lines 132a and plural source lines 132 are formed in a one-to-one correspondence. That is, as many source lead-out lines 132a as source lines 132 are formed on the array substrate 2. The plural source lead-out lines 132a are formed in the frame area 12. The source driving IC 142 and the source line 132 are connected through the source lead-out line 132a. That is, a source signal is supplied from the source driving IC 142 through the source lead-out line 132a.

The lead-out lines 131a and 132a are laid in the frame area 12 outside the display area 11. Then, the lead-out lines 131a and 132a are connected with the gate line 131 and the source line 132, respectively in the display area 11. In the structure of FIG. 1A, the gate driving IC 141 is provided below the display area 11. The gate lead-out line 131a is connected to the gate line 131 in the display area 11 from the side portion of the frame area 12. That is, the gate lead-out line 131a extends from the lower portion to the side portion of the frame area 12. Then, the gate lead-out line 131a is connected to the gate line 131 in the side portion of the frame area. Incidentally, the gate line 131 and the gate lead-out line 131a are formed of the same conductive film. Thus, the gate line 131 and the gate driving IC 141 are connected with the gate lead-out line 131a laid down in the frame area 12.

Further, almost half of the gate lead-out lines 131a are formed on the right-handed portion of the frame area 12. The remaining half of the gate lead-out lines 131a are formed in the left-handed portion of the frame area 12. That is, some gate lead-out lines 131a extend from the lower portion to the right-handed portion of the frame area 12 and are connected with the gate lines 131 at the right-handed edge of the display area 11. The remaining gate lead-out lines 131a extend from the lower portion to the left-handed portion of the frame area 12 and are connected with the gate lines 131 at the left-handed edge of the display area 11. The frame area 12 can be reduced.

In the liquid crystal display panel 1 of FIG. 1A, for example, the gate lead-out lines 131a on the left side and the gate lead-out lines 131a on the right side are alternately connected to the plural gate lines 13. For example, the odd-numbered gate line 131 is connected with the gate lead-out line 131a on the right side, and the even-numbered gate line 131 is connected with the gate lead-out line 131a on the left side. As described above, the plural gate lines 131 extend from both sides and are externally connected with the gate lead-out lines 131a. If the gate lead-out lines 131a are divided into the right side and left side of the display area 11 in this way, there is a fear that deviation is involved between a left-handed pixel line and a right-handed pixel line. In particular, in the above configuration, pixel signals are input alternately from the right side and the left side, so horizontally-striped unevenness are visually observed easily on a line basis.

The source driving IC 142 is also formed below the display area 11. Thus, the source lead-out line 132a is formed only in the lower portion of the frame area 12. Then, the source lead-out line 132a and the source line 132 are connected at the lower edge of the display area 11. Incidentally, the source line 132 and the source lead-out line 132a are made up of the same conductive film. As described above, the source line 132 and the source driving IC 142 are connected through the source lead-out line 132a laid in the frame area 12. A necessary number of lead-out lines 131a and 132a are formed at a predetermined pitch on the array substrate 2. Then, the lead-out lines 131a and 132a are formed inside the frame area 12.

As described, the plural gate lines 131 are arranged at regular pitches in the vertical direction. In the liquid crystal display panel 1, the length of the gate lead-out line 131a varies depending on the layout of the gate driving IC 141 and gate line 131. The plural gate lead-out lines 131a are different in length.

To be specific, as shown in FIG. 1A, the gate driving IC 141 is arranged on the left side of the source driving IC 142 in the frame area 12. Thus, the gate driving IC 141 is positioned on the left side in the array substrate 2. Therefore, the length of the gate lead-out line 131a (hereinafter abbreviated to “gate clockwise lead-out line 131a”) connected to the right side in the display area 11 is longer than that of the gate lead-out line 131a (hereinafter abbreviated to “gate counterclockwise lead-out line 131a”) connected to the left side. There is a possibility that a wiring resistance of the gate clockwise lead-out line 131a is higher than that of the gate counterclockwise lead-out line 131a. If the wiring resistance of the gate clockwise lead-out line 131a is different from that of the gate counterclockwise lead-out line 131a, horizontally-striped unevenness are visually observed in an image displayed on the liquid crystal display panel easily on a line basis. In this embodiment, the configuration efficient for reducing the horizontally-striped unevenness is employed.

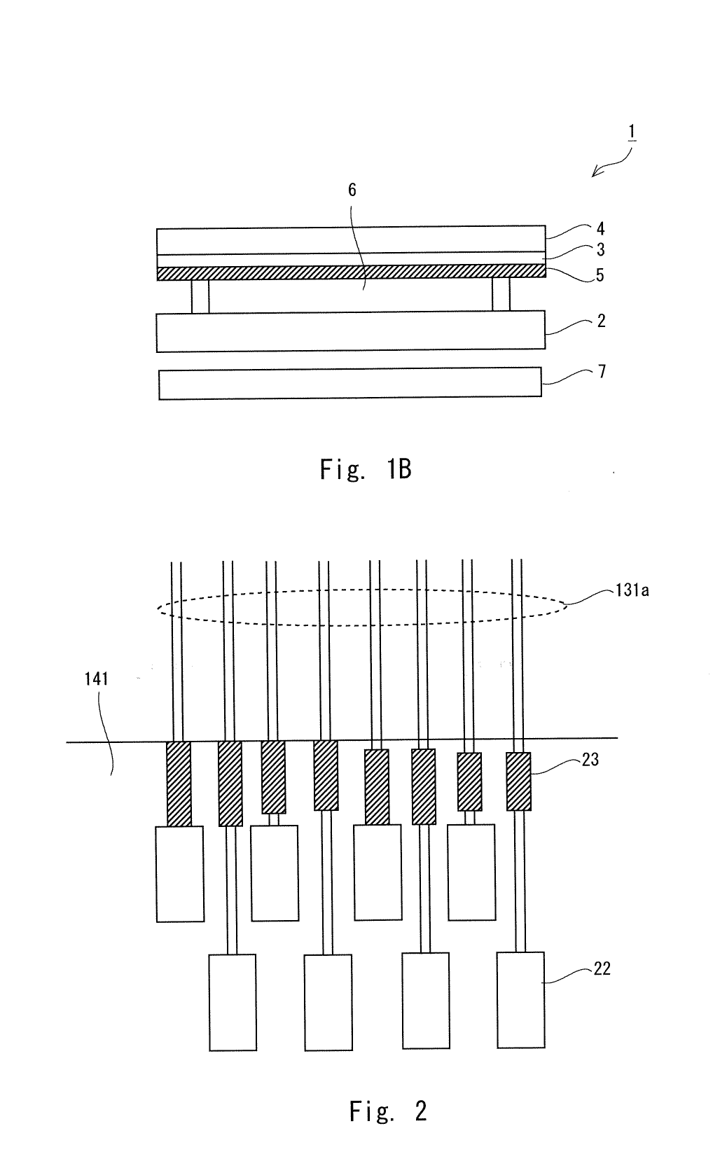

Referring to FIG. 2, the structure of the connection portion is described now. FIG. 2 is a plan view of the structure of the connection portion 23. In this embodiment, the connection portion 23 is formed near an area where the gate driving IC 141 is connected on the array substrate 2. To be specific, the connection portion 23 is formed below the frame area 12. The gate driving IC 141, a terminal COG 22, and the connection portion 23 are formed on the array substrate 2. Plural connection portions 23 correspond to plural gate lead-out lines 131a. The connection portion 23 connects the gate lead-out line 131a and adjusts a resistance difference between lines. The terminal COG 22 connects the gate lead-out line 131a with the gate driving IC 141. That is, the gate driving IC 141 is mounted through COG in such a state that the terminal COG 22 is exposed at the array substrate 2 surface.

The connection portion 23 is formed near the terminal COG 22. The connection portion 23 is connected between the gate driving IC 141 and the gate line 131. The connection portion 23 is formed in a given portion of the gate lead-out line 131a. For example, the connection portion 23 is formed between the terminal COG 22 and the gate lead-out line 131a or at any portion of the gate lead-out line 131a. In this embodiment, the connection portion 23 is formed inside the outer edge of the gate driving IC 141. The connection portion 23 is positioned just below the gate driving IC 141. As a result, a free space just below the gate driving IC 141 can be utilized to reduce the frame area 12.

The connection portion 23 functions to reduce a resistance difference between the wiring resistance of the gate counterclockwise lead-out line 131a and that of the gate clockwise lead-out line 131a. For example, the connection portion 23 is formed in only one of the gate counterclockwise line 131a and the gate clockwise lead-out line 131a. A resistance difference between the gate counterclockwise and clockwise lead-out lines 131a is adjusted. More specifically, in the liquid crystal display panel 1 of FIG. 1A, the connection portion 23 is formed in the gate counterclockwise lead-out line 131a of lower wiring resistance. Needless to say, the connection portion may be formed in each gate lead-out line 131a to adjust a resistance difference between upper and lower lines of the display area 11.

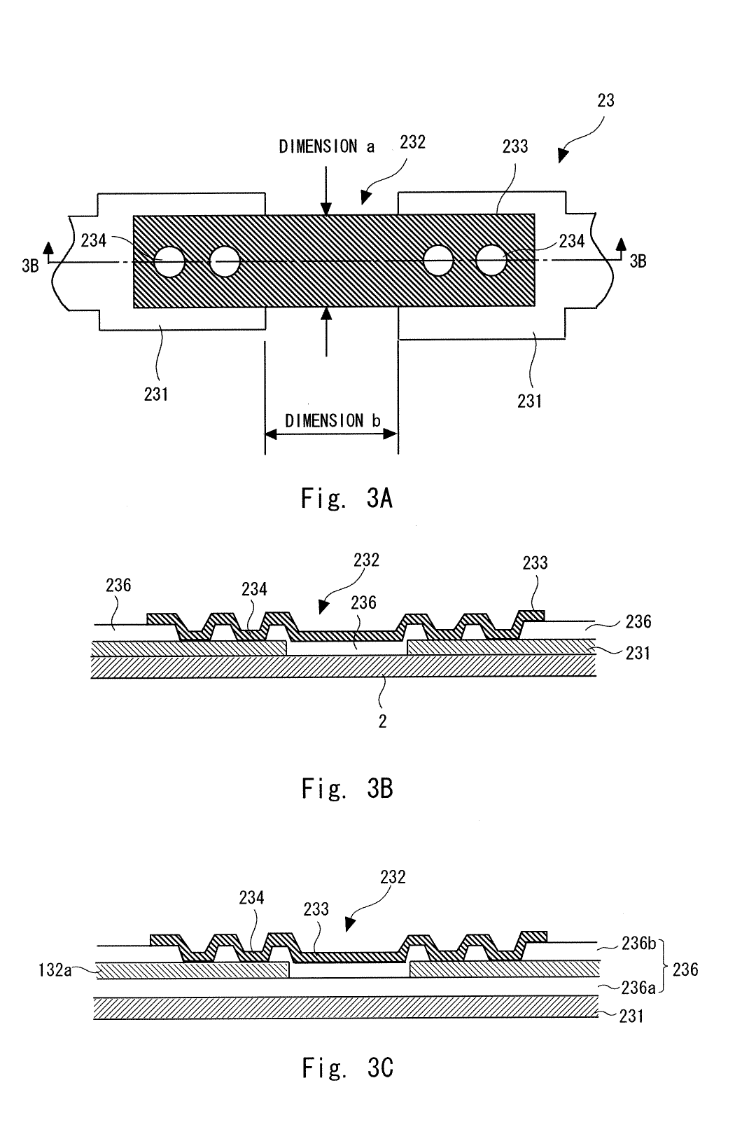

Referring to FIGS. 3A to 3C, detailed description is made of the connection portion 23 of the gate driving IC 141 of the present invention. FIGS. 3A to 3C are schematic diagrams of detailed configuration of the connection portion 23. FIG. 3A is a top view of the configuration of the connection portion 23, and FIG. 3B is a sectional view taken along the line 3B-3B of FIG. 3A. As shown in FIGS. 3A to 3C, the connection portion 23 includes a gate line film 231, a line cut portion 232, a connection conductive film 233, a contact hole 234, and an insulating film 236. In the connection portion 23, a wiring layer is temporarily changed.

The gate line film 231 is a conductor for forming the gate lead-out line 131a and partially divided. In other words, the gate lead-out line 131a is partially divided. The line cut portion 232 is a partially divided portion of the gate line film 231, which electrically cuts the gate line film 231. That is, the gate lead-out line 131a is cut at the line cut portion 232. The gate lead-out line 131a and the gate line 131 are made up of the same layer and thus formed of substantially the same material with the same film thickness.

The connection conductive film 233 is made of a conductor with higher resistance than a conductor for the gate line film 231. The connection conductive film 233 connects between insulated gate line films 231 with the line cut portion 232. That is, the connection conductive film 233 extends over the cut gate line films 231. The connection conductive film 233 partially overlaps with the gate line film 231. The connection conductive film 233 has a rectangular pattern shape. Incidentally, the shape of the connection conductive film 233 is not limited to a rectangular one. The dimension a (width a) of the short side of a rectangular of the connection conductive film 233 is appropriately set based on a resistance difference between the gate lines 131 led out in the clockwise and counterclockwise directions. In addition, the dimension b (length b) of the line cut portion 232 in the longitudinal direction, that is, an interval between the cut gate line films 231 is appropriately set based on a resistance difference between the gate lines 131 led out in the clockwise and counterclockwise directions. The connection portion 23 adjusts the gate lead-out lines 131a laid down in the clockwise and counterclockwise directions by setting at least one of the width and the length b. That is, a resistance of the connection portion 23 is set higher in the gate counterclockwise lead-out line 131a. Thus, a resistance value of the gate counterclockwise lead-out line 131a can be adjusted.

To be specific, in the shorter gate lead-out line 131a, the dimension of the connection portion 23 is set to have a high resistance. For example, the gate driving IC 141 is arranged on the left side, so the length of the gate counterclockwise lead-out line 131a is short. Thus, the length b of the line cut portion 232 in the gate counterclockwise lead-out line 131a is set long. Alternatively, the width of the connection conductive film 233 is set small. Needless to say, one or both of the length b and the width a can be changed. To elaborate, as the length of the gate lead-out line 131a decreases, the length b is set long. Alternatively, as the line length decreases, the width is set small. The cut gate lead-out lines 131a are connected in series through the connection conductive film 233. Thus, the dimension of the connection conductive film 233 can be set to have a resistance value based on a resistance difference between the gate lead-out lines 131a. For example, the dimension of the connection conductive film 233 can be set in accordance with the highest resistance of the gate lead-out line 131a.

An insulating film 236 is formed on the gate line film 231. The insulating film 236 is formed to cover the gate line film 231. The contact hole 234 is formed partly in the insulating film 236. The contact hole 234 is formed to connect between the gate line film 231 and the connection conductive film 233. Thus, the gate line film 231 and the connection conductive film 233 are connected together through the contact hole 234. The contact hole 234 is formed near the end portion of the gate line film 231 on the line cut portion 232 side. Two contact holes 234 are formed on both sides of the cut gate line film 231. As a result, if any contact hole 234 involves a connection failure, the films can be securely connected.

As shown in FIG. 3B, the gate line film 231 is patterned while being cut on the array substrate 2. An insulating film 236 is formed on the gate line film 231. The contact hole 234 is formed in the insulating film 236. The gate line film 231 is partially exposed at the contact hole 234. The gate line film 231 is divided at the line cut portion 232. The insulating film 236 is formed on the array substrate 2 from above the line cut portion 232. The connection conductive film 233 is formed on the insulating film 236 and connected with the gate line film 231 through the contact hole 234. The length of the connection conductive film 233 is longer than that of the line cut portion 232. The connection conductive film 233 overlaps with end portions of the cut gate line film 231.

As described above, according to the present invention, the connection portion 23 adjusts a wiring resistance of the gate counterclockwise lead-out line 131a and a wiring resistance of the gate clockwise lead-out line 131a such that the two resistance values are substantially equal to each other. Therefore, a resistance difference between upper and lower pixels of the display area 11 is substantially equal to a resistance difference between lines led out in a counterclockwise or clockwise direction. Thus, it is possible to reduce horizontally-striped unevenness that are visually observed easily in an image displayed on the liquid crystal display panel 1 due to a resistance difference between the gate lines 131 of the odd-numbered and even-numbered pixels. A resistance difference between the lead-out lines can be adjusted. Thus, a resistance value between lines can be reduced to suppress display unevenness. According to the present invention can reduce display unevenness due to a resistance disparity between the gate lead-out lines 131a. And a layout time for laying down lines to realize a predetermined resistance value can be shortened, because the resistance value can be set by just adjusting the dimension of the connection conductive film 233 at the connection portion 23.

The gate line film 231 can be patterned at the time of forming the gate line 131. The insulating film 236 can be patterned in the same step as the gate insulating film. The connection conductive film 233 and the pixel electrode can be patterned in the same step. In this case, the connection conductive film 233 is a transparent conductive film of high resistance such as an ITO film. That is, the connection conductive film 233 for adjusting a resistance difference has a resistance higher than that of the gate line film 231. It is possible to prevent the number of steps in a manufacturing process from increasing. Further, the contact hole 234 can be formed through a patterning step of each insulating film. Thus, the number of steps in a manufacturing process can be prevented from increasing.

Incidentally, the connection portion 23 may be used for the source lead-out line 132a. That is, a resistance difference is involved between the source lead-out lines 132a in accordance with a position of the source driving IC 142. For example, in the example of FIG. 1A, the source driving IC 142 is provided on the right side as viewed in the lateral direction of the display area. The leftmost source lead-out line 132a becomes longest. If the source lead-out lines 132a differ in resistance value as described above, the connection portion 23 can be also formed for the source lead-out line 132a. As a result, it is possible to prevent vertically-striped unevenness that would result from a resistance difference between the right and left source lead-out lines 132a in an image displayed on the display panel.

Further, the source lead-out lines 132a may be formed in the vertical direction of the display area 11 depending on the layout of driving IC. In this case, the connection portion 23 is formed in the source lead-out line 132a to thereby adjust a resistance difference between lines. Hence, display unevenness can be reduced.

In this case, the connection portion 23 is as shown in FIG. 3C. The source lead-out line 132a is made up of a conductive layer between the upper insulating film 236b and the lower insulating film 236a. Thus, a transparent conductive film in the same layer as the pixel electrode can be used for the connection conductive film 233. The connection portion 23 can be formed near the source driving IC 142. As a result, a resistance difference between lines can be reduced to suppress display unevenness.

For example, a method of determining the dimension of the connection conductive film 233 in the gate lead-out line 131a is described. First, the pattern and the number of gate lead-out lines 131a not having the line cut portion 232 are determined in accordance with the line layout to calculate a resistance value of each gate lead-out line 131a. A resistance difference between the gate lead-out lines 131a is calculated. Based on the resistance difference, the length b of the line cut portion 232 and the width a of the connection conductive film 233 are determined. As a result, it is possible to reduce a resistance difference between the lead-out lines. The dimension of the connection portion 23 can be similarly determined as for the source lead-out line 132a.

The position of the connection portion 23 is not limited a position near the gate driving IC 141 or the source driving IC 142 as shown in FIG. 2. As another embodiment of the present invention, variations in configuration and layout of the connection portion 23 are described below. Incidentally, the basic configuration of the connection portion 23 is the same as above, so its description is omitted here. In the following embodiments, the connection conductive film 233 may be a transparent conductive film of high resistance made of the same material as the pixel electrode.

Considering one of the right side and left side of the display area 11, the gate lead-out line 131a differs in length between the gate line 131 arranged below the display area 11 and the gate line 131 arranged above the display area 11. That is, the gate line 131 below the display area 11 is positioned closer to the gate driving IC 141 than the gate line 131 above the display area. The length of the gate lead-out line 131a connected to the gate line 131 below the display area is shorter than that of the gate lead-out line 131a connected to the gate line 131 above the display area. In other words, the line length of the gate lead-out line 131a increases toward the outer edge. As described above, the plural gate lead-outlines 131a have different lengths. Thus, a resistance difference between upper and lower lines may be adjusted by use of the connection portion 23.

### Second Embodiment

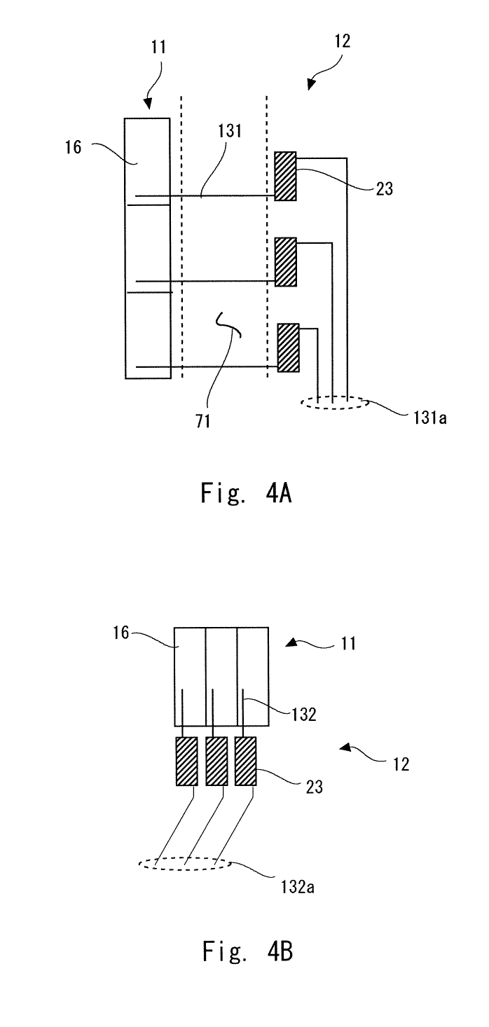

According to a second embodiment of the present invention, the connection portion 23 is provided near the side edge of the display area 11 in the frame area 12. For example, the connection portion 23 can be arranged near the display area 11 as shown in FIG. 4A. As shown in FIG. 4A, the connection portion 23 is arranged outside a common line CS 71 adjacent to the display area 11. The connection portion 23 is connected between the gate line 131 on the pixel 16 side and the gate lead-out line 131a. For example, if the connection portion 23 cannot be arranged between the outer edge of the gate driving IC 141 and the terminal COG 22, the connection portion 23 may be provided beside the display area 11. As a result, the connection portion 23 can be arranged in a simple manner without changing the size of the gate driving IC 141.

As described above, even if the connection portion 23 cannot be arranged between the outer edge of the gate driving IC 141 and the terminal COG 22, a resistance difference between lines can be adjusted. As described in this embodiment, the connection portion 23 may be formed anywhere in the gate lead-out line 131a extending from the lower portion to side portion of the frame area 12. That is, the connection portion 23 may be provided between a terminal connected to the gate driving IC 141 and the gate line 131. Needless to say, in this case, the connection portion 23 is provided on each of the right and left gate lead-out lines 131a. That is, if lines are led out from both sides of the display area 11, the connection portion 23 is formed on both of the right and left sides of the display area 11. If the connection portion 23 of the source lead-out line 132a is formed around the lower edge of the display area 11, the layout of FIG. 4B is obtained. As a result, a resistance difference between lines can be reduced, and display unevenness can be suppressed.

### Third Embodiment

In this embodiment, the connection portion 23 is formed just below the gate driving IC 141 and around the side edge of the display area 11. That is, if a resistance difference is large, and the connection portion 23 is increased in size, the connection portion 23 may be formed just below the gate driving IC 141 and around the side edge of the display area 11. The connection portion 23 may be formed at two or more locations of one gate lead-out line 131a. The connection conductive film 233 of the connection portion 23 is series-connected with the gate lead-out line 131a. The connection portion 23 is formed near the gate driving IC 141 as described in the first embodiment and around the side edge of the display area 11 as described in the second embodiment. A resistance value can be reliably corrected. That is, a margin for correcting a resistance can be set large. In this embodiment, a resistance value of at least one connection portion 23 can be corrected.

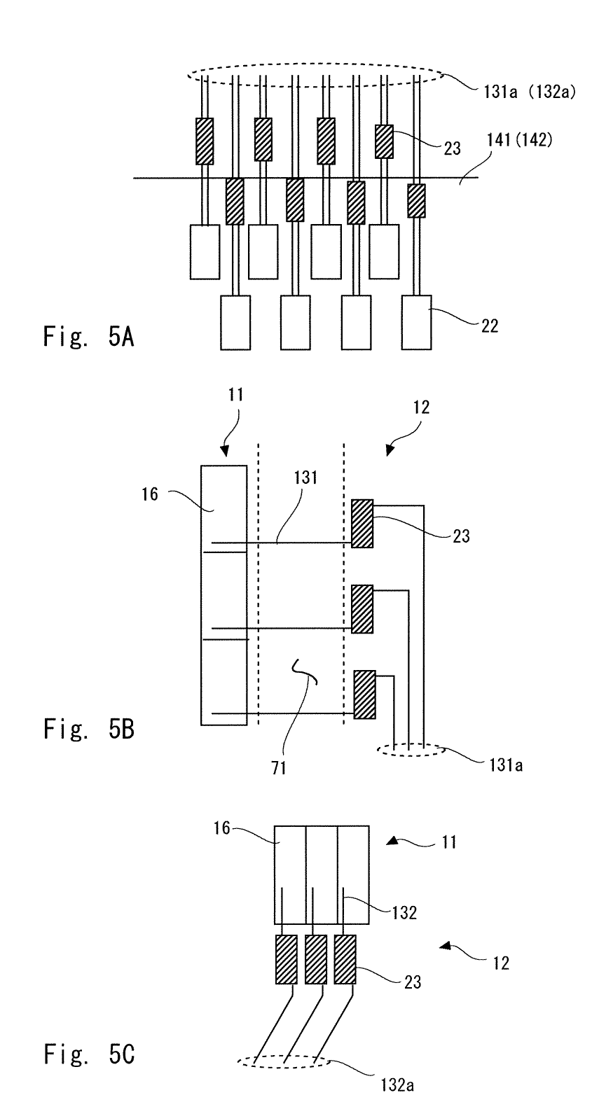

For example, as shown in FIG. 5B, the size of the connection portion 23 around the side edge of the display area 11 maybe fixed, and as shown in FIG. 5A, a resistance value of the connection portion 23 near the gate driving IC 141 can be adjusted. In this example, the connection portion 23 near the side edge of the display area 11 may have the same shape between the gate lead-out lines 131a.

Alternatively, as another configuration, the size of the connection portion 23 near the gate driving IC 141 may be fixed, and the connection portion near the side edge of the display area 11 may be changed to adjust a resistance value. In this way, the size of one connection portion is fixed and the size of the other connection portion is changed to thereby shorten a design time for layout.

Further, the above configuration is also applicable to the source lead-out line 132a. For example, if connecting two connection portions 23 of the source lead-out line 132a in series, the layout of FIGS. 5A and 5C is obtained. As a result, a resistance difference between lines can be reduced, and a margin for correcting a resistance value can be set large. Thus, display unevenness can be suppressed.

### Fourth Embodiment

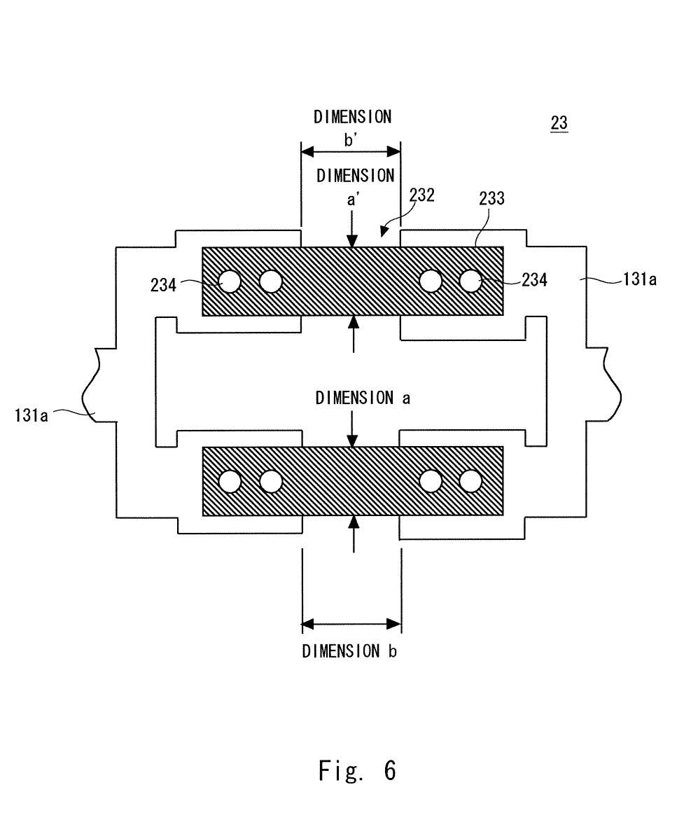

As shown in FIG. 6, the connection portions 23 may be connected in parallel with one gate lead-out line 131a. For example, the gate line film 231 is branched to pattern the connection portion. Thus, as shown in FIG. 6, two parallel lines are formed in a given portion of one gate lead-out line 131a. The line cut portion 232 is formed at the branch portion. The two connection conductive films 233 are formed on the branched gate line films 231. As a result, the connection conductive film 233 may be connected in parallel therewith. Thus, a margin for adjusting a resistance value can be set large. The total resistance value of the parallel connection portions 23 can be set half the resistance value of one connection portion.

For example, if a resistance value of the connection conductive film 233 in the connection portion 23 is higher than a resistance difference of the gate lead-out line 131a, and a resistance difference cannot be adjusted by correcting the line width and length of the clockwise and counterclockwise gate lead-out lines 131a, the above configuration is preferred. Thus, a resistance can be reliably adjusted. That is, if the minimum resistance value of the connection conductive film 233 in one connection portion 23 is preset, two connection portions 23 are connected in parallel to thereby adjust a smaller resistance difference. The two parallel-connected connection portions 23 have the same size. As described above, the connection portions 23 are arranged in parallel to thereby reduce a resistance difference between lines to ½ of the original difference. The connection portions 23 are arranged in parallel in at least some of the plural gate lead-out lines 131a. Hence, finer adjustment can be executed. A smaller resistance difference can be adjusted, and display unevenness can be suppressed. Further, three or more lines may be arranged in parallel. Needless to say, parallel connection portions 23 may be also formed in the source lead-out line. This produces the same beneficial effects.

### Fifth Embodiment

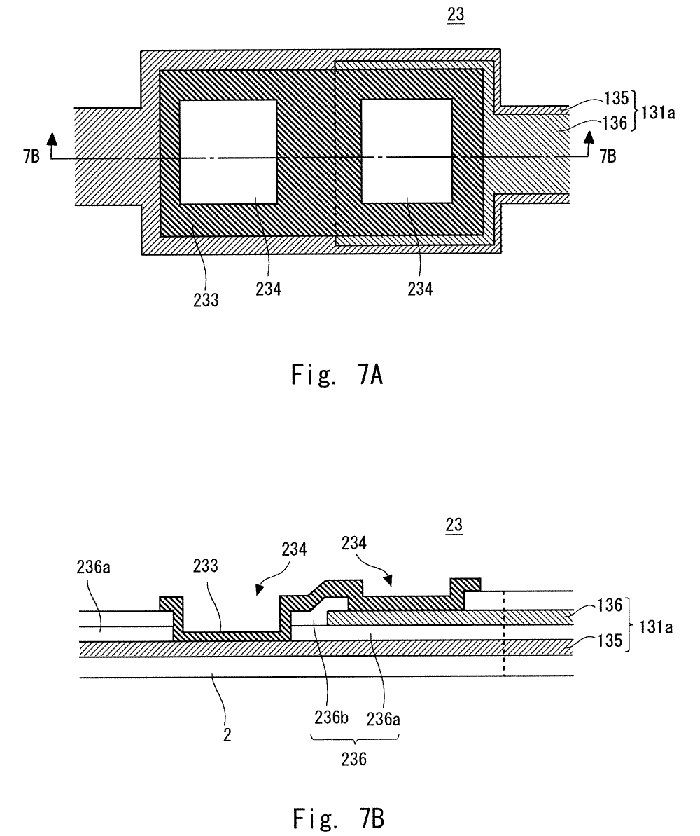

In this embodiment, as shown in FIGS. 7A and 7B, the gate lead-out lines 131a are formed in two layers. FIG. 7A is a plan view of the configuration of the connection portion 23, and FIG. 7B is a sectional view taken along the line 7B-7B of FIG. 7A. FIG. 7B is a sectional view of the configuration of the connection portion 23. The gate lead-out line 131a is not provided with the line cut portion 232. According to a fifth embodiment of the present invention, in the connection portion 23, the gate lead-out line 131a has a laminate structure of a first conductive layer 135 and a second conductive layer 136. That is, the gate lead-out line 131a of the first conductive layer 135 is branched to the two layers of the first conductive layer 135 and the second conductive layer 136. In other words, the gate lead-out line 131a is partially led out by the lower first conductive layer 135 and the upper second conductive layer 136 which are arranged in parallel. The second connection portion 23 is formed in the gate lead-out line 131a of the laminate structure, with the result that the gate lead-out line 131a of single-layer structure is realized. As described above, the two connection portions 23 are formed in one gate lead-out line 131a. As a result, a given section of the gate lead-out line 131a has the laminate structure of the first conductive layer 135 and the second conductive layer 136. That is, the gate lead-out line 131a takes the laminate structure between the two connection portions 23. The second conductive layer 136 is formed on the first conductive layer 135 through a lower insulating film 236a. The first conductive layer 135 and the second conductive layer 136 are connected together by the connection conductive film 233. A contact hole 234 is formed in an overlap portion between the first conductive layer 135 and the second conductive layer 136 to reach the second conductive layer 136. The connection conductive film 233 is connected with the second conductive layer 136 through the contact hole 234 in the upper insulating film 236b. The contact hole 234 is formed in the upper insulating film 236b and the lower insulating film 236a to reach the first conductive layer 135. The first conductive layer 135 and the second conductive layer 136 of different layers can be connected together through the connection conductive film 233. Here, the lower insulating film 236a of the insulating films 236 is formed in the same layer as the gate insulating film and the upper insulating film 236b is formed in the same layer as the interlayer insulating film.

As described above, a given portion of the gate lead-out line 131a has the laminate structure of the first conductive layer 135 and the second conductive layer 136. That is, the gate lead-out line 131a of single-layer structure including the first conductive layer 135 is branched to the laminate structure of the first conductive layer 135 and the second conductive layer 136 at the connection portion 23. The first conductive layer 135 and the gate line 131 can be formed in the same layer, and the second conductive layer 136 and the source line 132 can be formed in the same layer. The lower insulating film 235a formed in the same layer as the gate insulating film is provided between the first conductive layer 135 and the second conductive layer 136. The upper insulating film 236b in the same layer as the interlayer insulating film is formed on the second conductive layer. The connection conductive film 233 and the first conductive layer 135 are connected through the contact hole 234 formed in the lower insulating film 236a and the upper insulating film 236b, and the second conductive layer 136 and the connection conductive film 233 are connected through the contact hole formed in the upper insulating film 236b. A resistance value can be adjusted by appropriately setting the size of the second conductive layer 136. For example, a distance between the two connection portions 23 is increased to increase the length of the laminate structure. That is, as a distance between the connection portions 23 is increased, the length of the second conductive layer 136 is increased, so the total resistance value of the gate lead-out line 131a can be reduced. As described above, a resistance value between lines can be adjusted by correcting the distance between the connection portions 23. Alternatively, the width of the second conductive layer 136 is adjusted between the two connection portions 23. A resistance value of the laminate structure becomes small, and the total resistance value of the gate lead-out line 131a can be decreased. In this way, the length and width of the second conductive layer 136 in the laminate structure are adjusted to facilitate resistance value adjustment. Accordingly, the resistance difference can be adjusted by appropriately setting the width and length of the second conductive layer 136. Further, similar to the first to third embodiments, a resistance can be adjusted by appropriately setting the length and width of the connection conductive film 233. As described above, the first conductive layer 135 and the second conductive layer 136 that are laminated at the connection portion 23 are connected again on the terminal side and the gate line 131 side. As a result, a given portion of the gate lead-out line 131a takes the laminate structure to reduce a resistance value.

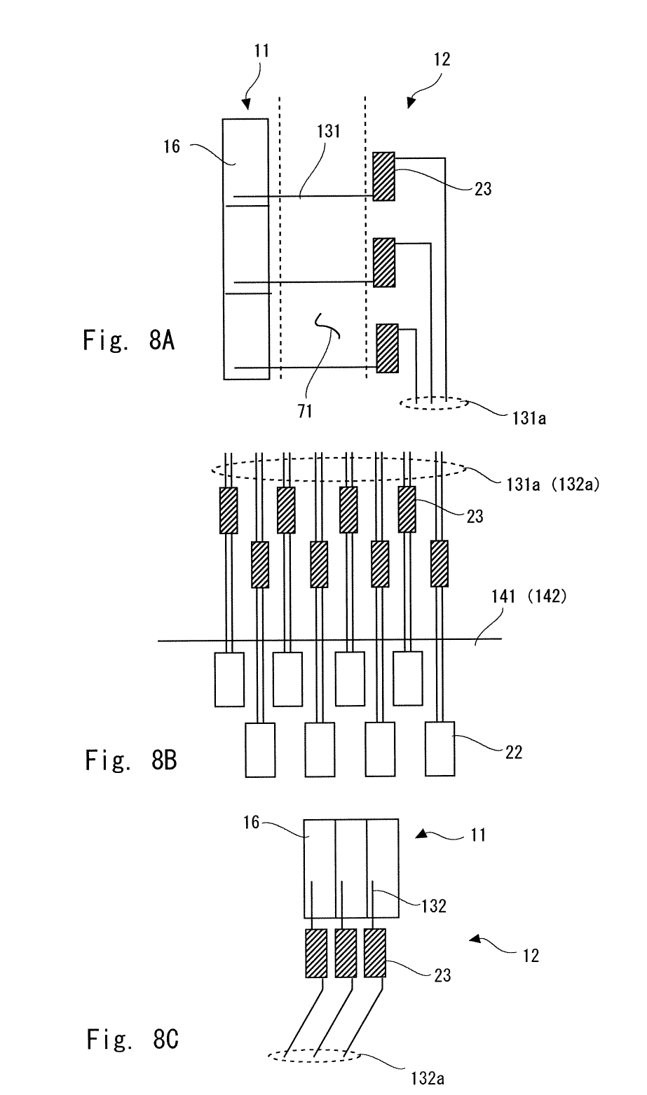

As shown in FIGS. 8A and 8B, the connection portion 23 may be arranged near the side edge of the display area 11 and near the gate driving IC 141. A resistance value is adjusted by changing the length and width of the second conductive layer 136 in the laminate structure between the two connection portions 23 formed near the side edge of the display area 11 and near the gate driving IC 141. In this example, the connection portion 23 is formed outside the outer edge of the gate driving IC 141. A resistance is adjusted by setting a position of the connection portion 23 on the gate driving IC 141 side. Thus, a resistance difference between lines can be reduced to suppress display unevenness. Needless to say, a resistance can be adjusted by appropriately setting a position of the connection portion 23 on the side edge of the display area 11. A resistance is adjusted by changing the length and width of the second conductive layer 136 in the laminate structure between the two connection portions 23. The above configuration is applicable to the source lead-out line 132a. That is, as shown in FIGS. 8B and 8C, two connection portions 23 are formed. A resistance can be adjusted by changing the length and width of the second conductive layer 136. As described above, a resistance value can be adjusted in a simple manner by the wiring structure of this embodiment.

The wiring structure of the first to fifth embodiments is applied to the display device to thereby reduce display unevenness. The application of the above wiring structure is not limited to the liquid crystal display device but the wiring structure is suitable for a flat panel display such as an organic EL display device. In addition, the wiring structure is applicable to a wiring substrate other than the array substrate 2. The wiring structure of the first to fifth embodiments is applicable to a lead-out line up to the scanning signal line or image signal line. As a result, display unevenness can be suppressed.

The first to fifth embodiments may be combined or applied to some of the plural lead-out lines. Further, the first to fifth embodiments may be applied to the liquid crystal display panel 1 of different configuration than that of FIG. 1A.

### Sixth Embodiment

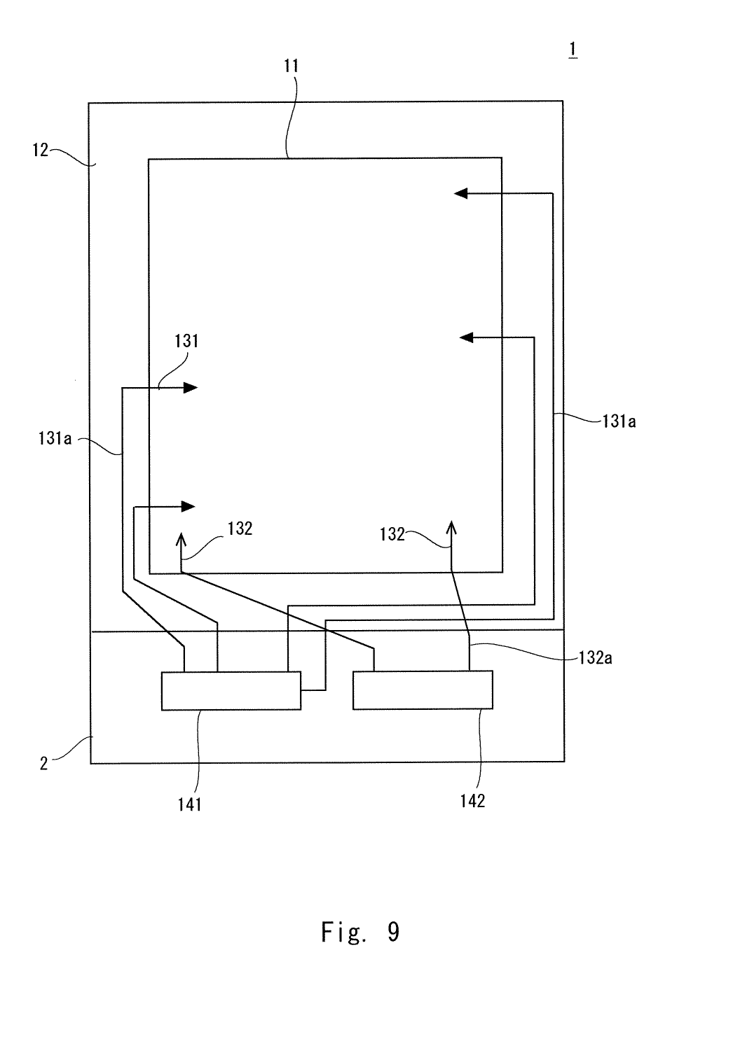

Referring to FIG. 9, the configuration of the liquid crystal display panel of this embodiment is described. FIG. 9 is a plan view of another structural example of the liquid crystal display panel to which the first to fifth embodiments are applicable. As shown in FIG. 9, the position of the gate lead-out line 131a differs between the upper portion and lower portion of the display area 11 to reduce the frame area 12 in some cases. For example, the gate lead-out line 131a corresponding to the gate line 131 below the display area 11 extends through the left side of the frame area 12. On the other hand, the gate lead-out line 131a corresponding to the gate line 131 above the display area 11 extends through the right side of the frame area 12. Even with this configuration, display unevenness tends to occur at the boundary between the upper portion and the lower portion of the display area 11. The display unevenness can be suppressed even in the liquid crystal display panel 1 of such configuration if the wiring structure of the first to fifth embodiments is applied thereto. For example, the connection portions 23 are formed on the side of the counterclockwise lead-out line 131 around the gate line 131 at the boundary. Then, a wiring resistance of the counterclockwise lead-out line 131a is set high such that the counterclockwise lead-out line 131a and the clockwise lead-out line 131a have the same resistance value. Alternatively, as described in the fifth embodiment, two connection portions 23 are formed in the counterclockwise lead-out line 131. Then, the length and width of the second conductive layer 136 in the laminate structure are adjusted such that the counterclockwise lead-out line 131a and the clockwise lead-out line 131a have the same resistance value. Incidentally, the example where the display area 11 is divided into two upper and lower portions is described here, but the present invention is not limited to the structural example where the area is divided in the same area ratio. For example, the area may be divided into the upper portion and the lower portion at a ratio of ⅓ to ⅔.

Further, a wiring resistance can be adjusted in each of the upper portion and lower portion of the display area 11. Here, the gate driving IC 141 is provided in the lower portion of the frame area 12. Thus, a distance from the gate driving IC 141 increases toward the gate line 131 above the display area 11. A line length and wiring resistance are increased in the gate lead-out line 131 of the upper gate line 131. A resistance value of the connection portion 23 is changed in order from the gate line 131 closest to the gate driving IC 141. That is, as a distance between the gate line 131 and the gate driving IC 141 decreases, a resistance value of the connection portion 23 of the gate lead-out line 131a is increased. In this case, the dimension of the connection portion 23 may be set such that a resistance increases toward the outer edge of the right-handed gate lead-out line 131a. In this case as well, the connection portion 23 of the first to fifth embodiments can be applied. As a result, the upper and lower lead-out lines 131a can have the same resistance. Hence, display unevenness can be suppressed.

### Seventh Embodiment

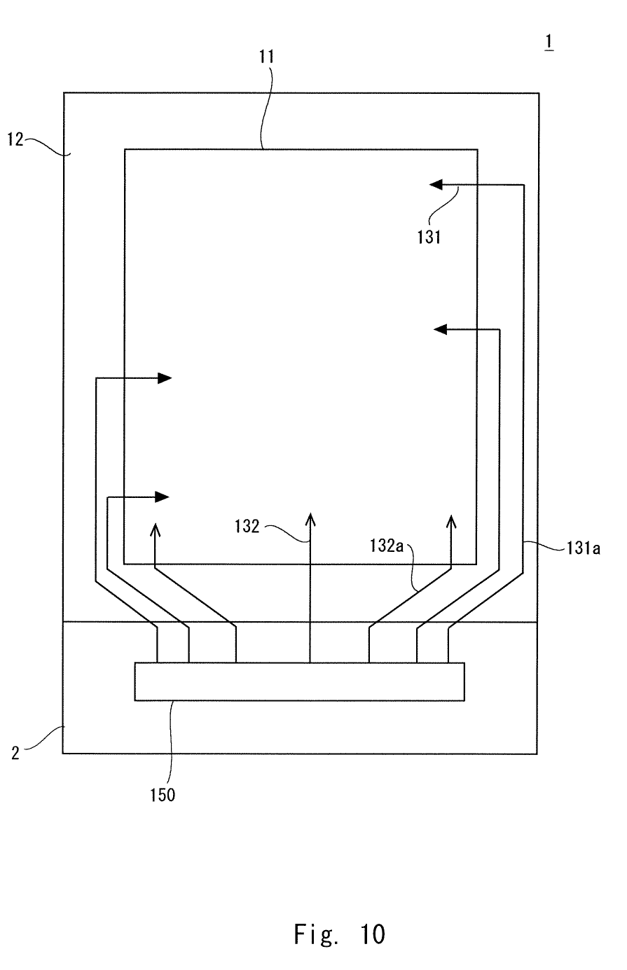

Referring to FIG. 10, the configuration of a liquid crystal display panel according to a seventh embodiment of the present invention is described. FIG. 10 is a plan view of another structural example of the liquid crystal display panel to which the first to fifth embodiments are applicable. As shown in FIG. 10, when the gate driving IC 141 and the source driving IC 142 are comprise as a single driving IC 150, similar problems arise. As shown in FIG. 10, the liquid crystal display panel 1 includes a single driving IC 150 connected to lines 131 and 132. In the liquid crystal display panel 1, the layout of the gate line 131 is similar to that of the liquid crystal display panel 1 of FIG. 9, while the source line 132 is symmetrical about the center line. Thus, the line length of the outer source line 132 (side portions of the driving IC 150) is longer than the line length of the inner source line 132 (central portion of the driving IC 150). Thus, a wiring resistance of the outer source line 132 is higher than that of the inner source line 132. As for the liquid crystal display panel 1 of this configuration as well, the wiring structure of the first to fifth embodiments is applied to suppress display unevenness.

### Eighth Embodiment

The first to fifth embodiments describe the case of applying the wiring structure of the present invention to the gate lead-out line or source lead-out line of the liquid crystal display panel. An eighth embodiment of the present invention describes an example where the above wiring structure is applied to a test lead-out line connected to the test circuit. The test circuit is used for simple lighting test upon display check after assembly of the display panel.

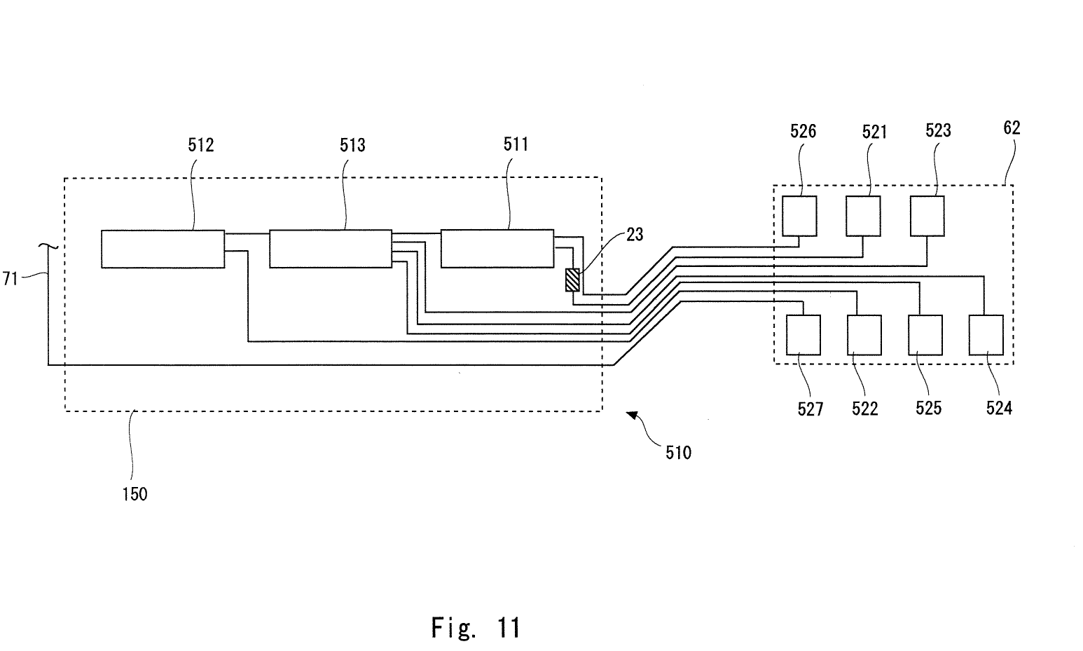

FIG. 11 schematically shows the configuration of the test terminal group 62 and the test circuit 510. As shown in FIG. 11, the clockwise gate line test circuit 511, the gate counterclockwise line test circuit 512, and the source-line test circuit 513 are arranged just below the driving IC 150. Here, the driving IC 150 is a shared driving IC of the gate driving IC 141 and the source driving IC 142. The clockwise gate line test circuit 511, the gate counterclockwise line test circuit 512, and the source-line test circuit 513 are formed on the array substrate 2.

The clockwise gate line test circuit 511, the gate counterclockwise line test circuit 512, and the source-line test circuit 513 are provided away from the test terminal group 62. That is, the test terminal group 62 is provided outside the test circuit 510.

The test circuit 510 includes the clockwise gate line test circuit 511, the gate counterclockwise line test circuit 512, and the source-line test circuit 513. The test terminal group 62 includes a TEST-clockwise gate terminal 521, a TEST-gate counterclockwise terminal 522, a terminal TEST-R 523 for inputting an R-test signal, a terminal TEST-G 524 for inputting G-test signal, a terminal TEST-B 525 for inputting a B-test signal, a switch terminal 526 for inputting a switching signal for turning ON/OFF the test circuit, and a COMMON terminal 527. The clockwise gate line test circuit 511 is connected to the TEST-clockwise gate terminal 521, and the switch terminal 526. The gate counterclockwise line test circuit 512 is connected to the TEST-gate counterclockwise terminal 522, and the switch terminal 526. The source-line test circuit 513 is connected to the terminal TEST-R 523, the terminal TEST-G 524, the terminal TEST-B 525, and the switch terminal 526. The COMMON terminal 527 is connected to a COMMON signal line such as the common CS line 71 of the display area 11 or a counter electrode of the opposing substrate.

The lead-out line length is substantially constant between the source-line test circuit 513 and the terminal TEST-R 523, the terminal TEST-G 524, and the terminal TEST-B 525. In contrast, the lead-out line length is longer between the gate counterclockwise line test circuit 512 and the TEST-gate counterclockwise terminal 522 than between the clockwise gate line test circuit 511 and the TEST-clockwise gate terminal 521. Thus, a resistance difference between the gate counterclockwise line test circuit 512 and the TEST-gate counterclockwise terminal 522 is larger than a resistance difference between the clockwise gate line test circuit 511 and the TEST-clockwise gate terminal 521.

In the related art, the display area 11 of the configuration of FIG. 10 is split into upper and lower portions in viewer's eyes upon display check due to the resistance difference, for example. To reduce the resistance difference, a line width between the clockwise gate line test circuit 511 and the TEST-clockwise gate terminal 521 and a line width between the gate counterclockwise line test circuit 512 and the TEST-gate counterclockwise terminal 522 are controlled to adjust a wiring resistance.

However, in recent years, the test circuit 50 proceeds toward shrinkage along with shrinkage of the driving IC 150, and a space for controlling a line width to adjust a wiring resistance is reduced. Thus, a simple lighting test is executed in such a state that the display area 11 is split into upper and lower portions. According to the present invention, as described in the first to fifth embodiments, the connection portion 23 can be provided between the clockwise gate line test circuit 511 and the TEST-clockwise gate terminal 521. A wiring resistance of the gate counterclockwise line test circuit 512 becomes equal to a wiring resistance of the TEST-gate counterclockwise terminal 522. For example, a split into upper and lower portions of the display area 11 can be reduced upon the simple lighting test. Thus, display check can be reliably performed.

The connection portion 23 as described in the first to eighth embodiments is formed in an area where no counter electrode of the opposing substrate is formed. Alternatively, in an area opposite to the connection portion 23, the counter electrode of the opposing substrate is removed. As described above, connection portion 23 is arranged outside of an area opposite to the counter electrode. That is, the connection portion 23 is formed outside of a region correspond to the counter electrode. As a result, it is possible to prevent short-circuiting and corrosion, and enhence a reliability. Further, the first to eighth embodiments can be combined as appropriate in accordance with a line layout. Further, the connection portion 23 may be partially formed only in the lead-out line. In the above wiring structure, the frame area 12 is utilized to realize simple configuration. Incidentally, the number of driving ICs may be two or more.

Thus, a resistance difference between the terminal and the lead-out line between signal lines is adjusted to suppress display unevenness.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A wiring structure, comprising:
a plurality of lead-out lines of different lengths formed on a substrate;
a plurality of line cut portions corresponding to the plurality of lead-out lines and cutting the lead-out lines; and
a connection portion connecting the lead-out lines cut by the line cut portion,
wherein a connection conductive film connecting the lead-out line cut by the line cut portion is formed in the connection portion, and
at least one of a width of the connection conductive film and a length of the line cut portion is changed between the plurality of lead-out lines in accordance with a resistance difference between the plurality of lead-out lines.

2. The wiring structure according to claim 1, wherein the connection conductive film is formed of a material with a higher resistance than the lead-out line.

3. The wiring structure according to claim 1, wherein the connection conductive film is parallel-connected with one lead-out line.

4. The wiring structure according to claim 1, further comprising:
a plurality of signal lines formed in a display area and connected with the lead-out lines; and
a driving circuit provided in a frame area outside the display area and supplying a signal to the signal line,
wherein the plurality of lead-out lines are formed in the frame area, and
the connection conductive film is formed near the driving circuit.

5. The wiring structure according to claim 1, further comprising:
a plurality of signal lines formed in a display area and connected with the plurality of lead-out lines,
wherein the plurality of lead-out lines are formed in a frame area outside the display area, and
the connection conductive film is formed near a side edge of the display area.

6. The wiring structure according to claim 5, wherein the connection conductive film is formed in each of two opposite side edges of the display area.

7. The wiring structure according to claim 1, further comprising:
a transparent pixel electrode of a display area,
wherein the connection conductive film is a transparent conductive film used for the transparent pixel electrode.

8. The wiring structure according to claim 1, further comprising:
an opposing substrate opposite to the substrate and including a counter electrode,
wherein the connection portion being formed outside an area opposite to the counter electrode.

9. A display device comprising a wiring board including the wiring structure according to claim 1.

10. A wiring structure, comprising:
a plurality of lead-out lines including a first conductive layer formed on a substrate;
a second conductive layer formed on the first conductive layer;
a lower insulating film formed between the first conductive layer and the second conductive layer;
two connection portions corresponding to the plurality of lead-out line and provided in the lead-out line such that a segment of the lead-out line has a laminate structure of the first conductive layer and the second conductive layer; and
a connection conductive film connecting between the first conductive layer and the second conductive layer in the connection portion,
wherein in the two connection portions, at least one of a width and length of the second conductive layer is changed between the plurality of lead-out lines in accordance with a resistance difference between the plurality of lead-out lines.

11. The wiring structure according to claim 10, wherein at least one of a width and length of the connection conductive film is changed between the plurality of lead-out lines in accordance with a resistance difference between the plurality of lead-out lines.

12. The wiring structure according to claim 10, wherein the connection conductive film is formed of a material with a higher resistance than the lead-out line.

13. The wiring structure according to claim 10, wherein the connection conductive film is parallel-connected with one lead-out line.

14. The wiring structure according to claim 10, further comprising:
a plurality of signal lines formed in a display area and connected with the lead-out lines; and
a driving circuit provided in a frame area outside the display area and supplying a signal to the signal line,
wherein the plurality of lead-out lines are formed in the frame area, and
the connection conductive film is formed near the driving circuit.

15. The wiring structure according to claim 10, wherein the plurality of signal lines formed in the display area and connected with the plurality of lead-out lines,
the plurality of lead-out lines are formed in the frame area outside the display area, and
the connection conductive film is formed near a side edge of the display area.

16. The wiring structure according to claim 15, wherein the connection conductive film is formed in each of two opposite side edges of the display area.

17. The wiring structure according to claim 10, further comprising:
a transparent pixel electrode formed in a display area,
wherein the connection conductive film is a transparent conductive film used for the transparent pixel electrode.

18. The wiring structure according to claim 10, further comprising:
an opposing substrate opposite to the substrate and including a counter electrode,
the connection portion being formed outside an area opposite to the counter electrode.

19. A display device comprising a wiring board including the wiring structure according to claim 10.
